(19) United States
(12) Patent Application Publication
(10) Pub. No.: US 2012/0135270 A1
(43) Pub. Date: May 31, 2012

(54) Layer System with Improved Corrosion Resistance

(75) Inventors: Klaus Wilbuer, Solingen (DE); Meik Gray, Solingen (DE); Matthias Patzelt, Haan (DE)

(73) Assignee: MTV METALLVEREDLUNG GMBH & CO. KG, Solingen (DE)

(21) Appl. No.: 13/260,270

(22) PCT Filed: Mar. 24, 2010
(86) PCT No.: PCT/EP2010/001817

§ 371 Date: Dec. 10, 2011

(30) Foreign Application Priority Data
Mar. 24, 2009 (EP) 09 004162.5

(51) Int. Cl. B32B 15/01; B05D 1/36

(52) U.S. Cl. 428/646; 428/647; 428/648; 428/649; 428/656; 427/404

(57) ABSTRACT

The present invention relates to a layer system for coating a substrate surface and to a method for coating a substrate surface with a corresponding layer system, the layer system comprising at least two layers. One layer is a metal-nickel-alloy layer with a metal of the group comprising tin, copper, iron, tungsten and cobalt or an alloy of at least one of said metals, and the other layer is a layer of a metal of the group comprising nickel, copper, tin, molybdenum, niobium, cobalt, chromium, vanadium, manganese, titanium and magnesium, or an alloy of at least one of said metals. The layer system according to the invention is characterized by a high mechanical stability and great corrosion resistance.

The present invention concerns a layer system for coating a substrate surface which layer system exhibits improved corrosion resistance.

The deposition of metal layers or metal alloy layers on the surface of substrates has been known for a very long time. In this connection, the substrates to be coated can be conducting metallic components as well as non-conducting substrates such as e.g. plastic components. On the one hand, the deposited metal layers can change the substrate surfaces functionally and, on the other hand, decoratively. While the decorative coating of substrate surfaces generally is directed only to the visual appearance of the deposited metal layers, in the field of functional deposition of metal layers a modification of the mechanical and/or chemical surface properties of the substrates is desired. For example, frictional wear resistance, attrition resistance, surface hardness or corrosion resistance of the surface of the substrate can be modified by deposition of suitable layers. In principle, in this connection the galvanic deposition of layers as well as the autocatalytic deposition of layers are known.

An important role in the field of functional coatings is played by chromium layers which are used as a coating for metal surfaces in order to improve the metal surfaces in particular with respect to their wear resistance and corrosion resistance. For example, galvanic deposition of hard chromium layers from appropriate chromium electrolytes on metal surfaces is known wherein the thus obtained hard chromium coating in general has a greater hardness than the material from which the substrate to be coated is manufactured. Moreover, these layers are also characterized by excellent corrosion resistance.

Hard chromium layers are, for example, used in the field of construction technology for hydraulic components such as hydraulic cylinders and hydraulic pistons, for print rollers in the field of printing machine technology or also in the field of motor construction, for example, for coating the valve stems.

A further field of application of such coatings is the corrosion-resistant finishing of components and facility components in the field of marine construction technology as well as offshore technology. In this connection, the constant contact of the components and facility components with seawater causes drastic corrosive attacks that are to be prevented. In this connection, the use of hard chromium layers has been found to be suitable only to a limited extent for protecting the corresponding components and facility components with regard to their mechanical load requirements as well as with regard to their corrosion resistance.

A further disadvantage of the hard chromium layers known from the art is that generally they are deposited from chromium(VI)-containing electrolytes. Chromium(VI) however is suspected to be carcinogenic and the use of chromium(VI)-containing electrolytes should therefore be avoided. In the prior art, various attempts have therefore been made in order to deposit layers with comparable mechanical and chemical properties while eliminating the chromium(VI)-containing electrolytes. For example, European patent EP 0 672 763 B1 discloses a method for coating a metal surface in which on the metal surface in a first step a nickel-phosphorus alloy layer is deposited onto which then a silicon layer is applied in a vacuum chamber by use of an ion beam.

However, such a method is very cost intensive and as a result of the required vacuum chamber also applicable only for appropriately small components.

It is therefore an object of the present invention to provide a layer system which, by avoiding the use of chromium(VI)-containing electrolytes, is suitable as a substitute for the hard chromium layers described in the prior art and, moreover, can be deposited on components of any size. Moreover, it is an object of the present invention to provide a method for depositing such a layer system.

This object is solved with respect to the layer system by a layer system for coating a substrate surface comprised of a first inner layer and an second outer layer that is deposited on the first layer wherein one layer is a metal-nickel alloy layer with a metal of the group consisting of tin, copper, iron, tungsten, and cobalt, or an alloy of at least one of these metals, and the other layer is a layer of a metal of the group consisting of nickel, copper, tin, molybdenum, niobium, cobalt, chromium, vanadium, manganese, titanium and magnesium, or an alloy of at least one of these metals.

It has been found that a layer system, comprised of a metal-nickel alloy layer with a metal of the group consisting of tin, copper, iron, tungsten, and cobalt, or an alloy of at least one of these metals, and a layer of a metal of the group consisting of nickel, copper, tin, molybdenum, niobium, cobalt, chromium, vanadium, manganese, titanium and magnesium, or an alloy of at least one of these metals, results in a coating which, on the one hand, with regard to its mechanical stability fulfills the requirements posed on a hard chromium layer and, on the other hand, has an excellent corrosion resistance. As a metal-nickel alloy layer in particular a tin-nickel alloy layer is to be considered.

For testing the corrosion resistance of the layer system and in particular for evaluating the corrosion resistance relative to seawater, the substrates coated in accordance with the invention are exposed in compliance with ASTM standard G48 under acidic conditions to an aqueous iron(III)-chloride-containing solution. The layer systems according to the invention exhibit under these conditions an excellent corrosion resistance of more than 72 hours whereby this standard is fulfilled and the layer systems according to the invention in this respect are seawater-fast. i.e., seawater-resistant.

In a preferred embodiment of the invention, the metal-nickel alloy layer that is in particular embodied as a tin-nickel alloy layer has a layer thickness of at least 1 μm, preferably of at least 5 μm, and even more preferred of at least 10 μm. Tests have shown that a layer thickness of 3 μm is sufficient in order to achieve the corrosion resistance in accordance with ASTM standard G48. Therefore, the special advantage of the layer systems according to the invention resides in that an excellent corrosion resistance can be achieved with a comparatively thin layer thickness. Even though the corrosion resistance, to be characterized as seawater-fast according to ASTM standard G48, is already achieved for a layer thickness of only 3 μm, the layer thickness of the layer systems according to the invention can be designed to be greater, optionally in order to withstand other, in particular mechanical, actions. For example, the layer thickness can be also 20 μm, 30 μm, 40 μm or even thicker, depending on the application.

A layer system preferred in accordance with the invention is a layer system in which a layer of a metal of the group consisting of nickel, copper, tin, molybdenum, niobium, cobalt, chromium, vanadium, manganese, titanium, and magnesium, or an alloy of at least one of these metals, is deposited as a first layer on a substrate surface onto which then a metal-nickel alloy layer with a metal of the group consisting of tin, copper, iron, tungsten, and cobalt, or an alloy of at least one of these metals, is deposited. As a metal-nickel alloy layer, a tin-nickel alloy layer is preferred in particular.

Without being tied to this theory, the inventors assume at this time that an electrochemical stabilization of the metals that form the individual layers in the layer system according to the invention is generated by means of which the free corrosion potential at the surface is significantly improved. This assumption is supported in that corrosion tests have demonstrated that the individual layers have a significantly reduced corrosion resistance in comparison to the layer system, respectively. The tin-nickel layer that is deposited as a second outer layer in a preferred embodiment is in a desirable way seal-tight, i.e., hermetically closed. However, macro fractures may be formed which enable diffusion of corrosive media into the layer and therefore a contact of the corrosive media with the first inner layer. However, this has no effect on the corrosion resistance of the layer system which also supports the assumption of a mutual electrochemical stabilization of the layers.

In a further preferred embodiment of the layer system according to the invention the first inner layer is bronze or a nickel-phosphorus alloy layer.

With respect to the method, the object of the invention is solved by a method for coating a substrate surface, in particular a metal substrate surface, which comprises at least the method steps:
deposition of a first inner layer on a substrate surface;
deposition of a second outer layer,
   wherein as one layer a metal-nickel alloy layer With a metal of the group consisting of tin, copper, iron, tungsten, and cobalt, or an alloy of at least one of these metals, and as the other layer a layer of a metal of the group consisting of nickel, copper, tin, molybdenum, niobium, cobalt, chromium, vanadium, manganese, titanium, and magnesium, or an : alloy of at least one of these metals, is deposited.

In a preferred embodiment of the method according to the invention, as a first layer a metal of the group consisting of nickel, copper, tin, molybdenum, niobium, cobalt, chromium, vanadium, manganese, titanium and magnesium, or an alloy of at least one of these metals, is deposited and as a second layer a metal-nickel alloy layer with a metal of the group consisting of tin, copper, iron, tungsten and cobalt, or an alloy of at least one of these metals, is deposited. A tin-nickel alloy layer is preferred as a metal-nickel alloy layer.

Particularly preferred is the deposition of the metal-nickel alloy layer with a layer thickness of at least 1 μm, preferably of 3 μm, wherein also thicker layers of, for example, 10 μm, 20 μm or 30 μm can be adjusted.

As a first layer, for example, a bronze layer or a nickel-phosphorus alloy layer can be deposited.

The deposition of the individual layers of the layer system, as a function of the type of layer, can be realized in the conventional way as described in the art autocatalytically or galvanically. For example, for the deposition of a bronze layer as a first inner layer an electrolytic deposition is preferred with supply of a suitable deposition voltage between the substrate surface and a counterelectrode and use of conventional bronze electrolytes (aqueous, copper-containing and tin-containing electrolyte) while the deposition of, for example, a nickel-phosphorus alloy layer is preferably realized autocatalytically with use of an electrolyte comprising an appropriate reducing agent such as, for example, sodium hypophosphite, but can also can be deposited electrolytically.

The deposition of the metal-nickel alloy layer to be provided according to the invention can also be done galvanically with supply of a deposition voltage between the substrate surface and a suitable couriterelectrode or autocatalytically by use of suitable reducing agents.

The layer systems deposited according to the invention are suitable in particular for coating components in the field of hydraulic technology, for example, pressure cylinders and pressure pistons, for coating of print rollers in the field of printing machine technology, for coating facility parts and components in the field of marine construction technology, in particular in the field of shipbuilding as well as offshore production of natural gas and oil, as well as in the field of motor construction.

What is claimed is:

1. Layer system for coating a substrate surface, the layer system comprised of a first inner layer and a second outer layer deposited on the first inner layer, wherein one of the first and second layers is a metal-nickel alloy layer with a metal of the group consisting of tin, copper, iron, tungsten, and cobalt, or an alloy of at least one of these metals, and the other one of the first and second layers is a layer of a metal of the group consisting of nickel, copper, tin, molybdenum, niobium, cobalt, chromium, vanadium, manganese, titanium and magnesium, or an alloy of at least one of these metals.

2. Layer system according to claim 1, wherein the metal-nickel alloy layer has a layer thickness of at least 1 μm.

3. Layer system according to claim 1, wherein the metal-nickel alloy layer forms the second outer layer.

4. Layer system according to claim 1, wherein the layer system has a corrosion resistance that fulfills the standard according to ASTM G48 method A.

5. Layer system according to claim 1, wherein the first inner layer is formed by a bronze or a nickel-phosphorus alloy layer.

6. Method for coating a substrate surface, comprising the method steps of:
depositing a first inner layer on a substrate surface;
of depositing a second outer layer on the first layer,
wherein as one of the first and second layers a metal-nickel alloy layer with a metal of the group consisting of tin, copper, iron, tungsten and cobalt, or an alloy of at least one of the metals, is deposited and as the other one of the first and second layers a layer of a metal of the group consisting of nickel, copper, tin, molybdenum, niobium, cobalt, chromium vanadium, manganese, titanium and magnesium, or an alloy of at least one of these metals, is deposited.

7. Method according to claim 6, wherein as the first layer a layer of a metal of the group consisting of nickel, copper, tin, molybdenum, niobium, cobalt, chromium, vanadium, manganese, titanium and magnesium, or an alloy of at least one of the metals, is deposited and as the second layer a metal-nickel alloy layer is deposited.

8. Method according to claim 6, wherein the metal-nickel alloy layer is deposited with a layer thickness of at least 1 μm.

9. A coating comprising a layer system according to claim 1 as a for corrosion-resistant finishing of components exposed to seawater and/or of hydraulic components.
